(19) United States
(12) Patent Application Publication
(10) Pub. No.: US 2003/0003796 A1
(43) Pub. Date: Jan. 2, 2003

(54) Line cord strain relief attachment with integral sealing ribs for use with telephone test set

(75) Inventor: Edward J. Zoiss, Moorpark, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: HARRIS CORPORATION

(21) Appl. No.: 09/896,837

(22) Filed: Jun. 29, 2001

(51) Int. Cl. H01R 13/58

(52) U.S. Cl. 439/455

(57) ABSTRACT

A strain relief attachment for attaching a telephone communication cord to a telephone test set has a line cord strain relief element, a grooved neck portion of which has at least one moisture barrier rib and is insertable through a tunnel at an end region of the test set, so as to be adjacent to a strain relief engagement surface. The strain relief element includes a flange that conforms with the test set adjacent to the tunnel. As a line cord retention plug is inserted into the grooved neck portion of the line cord strain relief element and engages a wall surface of the strain relief engagement cavity, it draws the line cord strain relief element into the test set, and biases the flange against the external surface of the test set. The retention plug has a nib for manually seizing the line cord retention plug, without need for a tool for the purpose.

### FIELD OF THE INVENTION

The present invention relates in general to portable telecommunication devices, such as telephone test sets, and is particularly directed to a line cord strain relief attachment with one or more integral sealing ribs, to facilitate replacement of the line cord and provide a secure strain-relieving, enhanced weatherproof seal at the interface of the line cord with the body of the test set.

### BACKGROUND OF THE INVENTION

Telecommunication devices, including portable devices, such as, but not limited to telephone craftsperson's test sets, are customarily equipped with a wireline link, through which the device may be physically and electrically connected with a telecommunication port of another piece of equipment. As a non-limiting example, in the case of a standard telephone device, such a wireline communication link may be configured as shown in FIG. 1 to include a section of multi-wire cable 10, opposite ends of which are equipped with respective RJ45-style modular plugs 12 and 14, for releasably mating with an RJ45 telephone jack of the device and that of a network installation.

As further shown in FIG. 1, in the case of a telephone test set, the line cord may also include a second multi-wire cable 11, one end of which is terminated at the RJ45 style modular plug 12 that is adapted to be coupled with an associated jack of internal circuitry of the test set, and the other end of which is provided with a separate a set of (alligator) clips 23 and 25 for enabling the test set to be coupled to a variety of connection points of a telephone network.

To provide strain relief for the connection of the line cord with the telecommunication device, it has been practice to employ a physical interface having a serpentine or tortuous path for the line cord. While such a strain relief interface may provide some degree of protection for the line cord attachment of a consumer telephone device, it is wholly inadequate for a device such as a telephone test set, which will be exposed to a variety of physical hazards, including severe physical handling and the environment. This not only mandates the use of a strain relief configuration that is more robust and provides a barrier against the entry of moisture and foreign matter, but one which facilitates replacement of the line cord.

Advantageously, the line cord strain relief attachment disclosed in the U.S. Pat. No. 5,755,590 (hereinafter referred to as the '590 patent) successfully addresses this problem by providing a line cord and line cord attachment, diagrammatically shown in FIGS. 2 and 3. As shown therein, this improved line cord attachment, shown generally at 20, incorporates a strain relief element 30, which is configured to be sealed against the outer surface of the body of the device and coupled with an interior cavity thereof, such as the battery compartment of a test set. This improved line cord attachment and strain relief configuration not only facilitates access to and replacement of the line cord, per se, but does so without having to otherwise interfere with the main cavity of the device (test set).

For this purpose, the telecommunication device itself includes a line cord strain relief engagement cavity 32, formed between generally flat sidewalls 34 and 36 of a pair of spaced apart land portions 37 and 39 of an interior (battery) compartment 40. The geometry of the strain relief engagement cavity 32 is further defined by a rear wall 42 and a pair of spaced apart front walls 44 and 46 of respective projections 47 and 49 of the land portions 37 and 39. The front walls 44 and 46 of the cavity 32 have a slot 51 through which the line cord extends into the compartment 40. A fixed battery contact wall 53 has a gap 55 associated with the slot 51, so as to allow the line cord 10 to pass through the fixed battery contact wall 53 to a portion of the battery compartment containing a printed wiring board.

The strain relief engagement cavity 32 communicates with an exterior surface 61 of the test set body by means of a passageway or tunnel 63. The line cord passageway 63 has non-round cross-section, for example a generally rectangular cross-section. This shape serves to prevent rotation of and is sized to snugly receive the line cord strain relief element 30, the shape of which corresponds to that of the passageway 63.

The line cord stain relief element 30 is preferably comprised of a suitable flexible and waterproof material, such as neoprene rubber, as a non-limiting example. A first end 71 of the strain relief element 30 has a notched or grooved neck 73 that is insertable into the cavity 32. The surface of the grooved neck portion 73 of the strain relief element 30 is non-parallel with the planar surface of the rear wall of the cavity 32, so that the application of a force along the grooved neck by way of a wedge-shaped line cord retention plug 75 of hard plastic material, causes the line cord strain relief element 30 to be drawn into the body of the test set.

The distance between a surrounding flange 81 of the strain relief element and the grooved neck 73 of the strain relief element 30 is such that insertion of the retention plug 75 into the test set cavity 32 will cause the line cord strain relief element 30 to be drawn or urged into the tunnel 63, and bring the flange 81 into snug abutment against the exterior surface 61 of the test set body. Projecting from the flange 81 is a line cord shroud 83 having a longitudinal bore 85 that is sized to snugly receive the line cord 10, causing the shroud to provide a weatherproof seal around the line cord, as it extends through the strain relief element and into the test set.

To releasably secure the strain relief element 30 with the test set, the line cord retention plug 75 contains a generally rectangular T-shaped slot 87 which conforms with the grooved neck 73 of the line cord strain relief element 30. These mutually conforming shapes of the T-shaped slot 87 within retention plug 75 and the grooved neck 73 of the strain relief element 30 enable the retention plug 75 to capture the strain relief element 30, as the retention plug 75 is inserted into the cavity 32.

The grooved neck 73 of the strain relief element 3 is inserted from outside of the test set body through the tunnel 63 and into the line cord strain relief engagement cavity 32, as shown by the arrow 91. The first end of the line cord 10 is fed through the slot 55 to allow the RJ45 style modular plug 12 to be plugged into an RJ45 style modular jack of the test set circuitry.

The cord retention plug 75 is then inserted into the cavity 32, as shown by arrow 93, so that the grooved neck 73 of the strain relief element 30 may be is captured within the T-shaped neck of the cord retention plug 75. The wedge shapes of the cavity 32 and the cord retention plug 75 push the retention plug deeper into the cavity 32, so as to cause the line cord strain relief element 30 to be urged into the body of the test set, tightening the surface 77 of the flange 81 of the line cord strain relief element 30 against the exterior surface 61 of the test set, and providing a seal around the passageway 63.

To replace the line cord, the cord retention plug 75 may be removed by means of a suitable tool, such as a screwdriver or the like, so that the retention plug becomes detached from the grooved neck 73 of the strain relief element 30. This frees the neck end of the strain relief element, so that the element 30 may be pulled out of the tunnel 63, allowing the line cord to be fully removed from the test set.

Now although engagement of the flange of the line cord strain relief element of the type disclosed in the '590 patent against the outer surface of the test set is intended to provide a barrier against the entry of moisture and foreign matter through the line cord passageway, it has been found that repeated subjection of the line cord strain relief attachment to a variety of deflection forces encountered in typical everyday use prevents a moisture barrier or seal from being continuously applied between the entirety of the surface of the attachment flange and the exterior surface of the test set. In addition, removal of the cord retention plug requires a suitable tool for the purpose.

### SUMMARY OF THE INVENTION

In accordance with the present invention, the less than perfect continuous seal functionality of the line cord strain relief attachment of the '590 Patent is remedied by incorporating one or more sealing ribs or rings around the outer surface of the strain relief element. The sealing ribs are sized to provide a tight moisture and foreign matter entry barrier between the interior wall surface of the line cord-insertion tunnel and the outer surface of the strain relief element. In addition, to obviate having to use a tool to insert and/or remove the cord retention plug, the plug has a modified inverted U-shape that incorporates a nib or gripping projection, which can be readily seized between a user's thumb and forefinger, thereby allowing manual insertion and removal of the plug.

### BRIEF DESCRIPTION OF THE DRAWINGS

FIG. 1 diagrammatically shows a line cord terminated with RJ45 style modular plugs and alligator clips;

FIG. 2 diagrammatically shows a line cord of the type illustrated in FIG. 1 and incorporating a line cord strain relief attachment of the type disclosed in the '590 Patent;

FIG. 3 is a partial perspective view of test set engagement of the line cord strain relief attachment disclosed in the '590 Patent; and

FIG. 4 is an enlarged partial perspective view of a test set and the improved line cord strain relief attachment of the present invention.

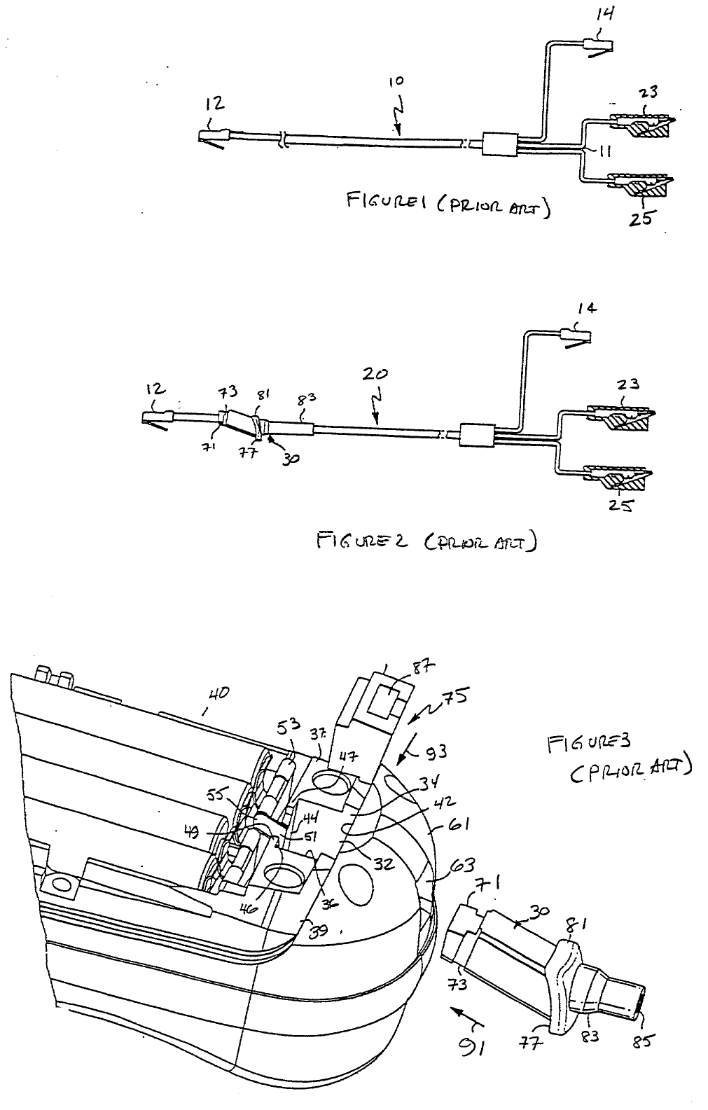

### DETAILED DESCRIPTION

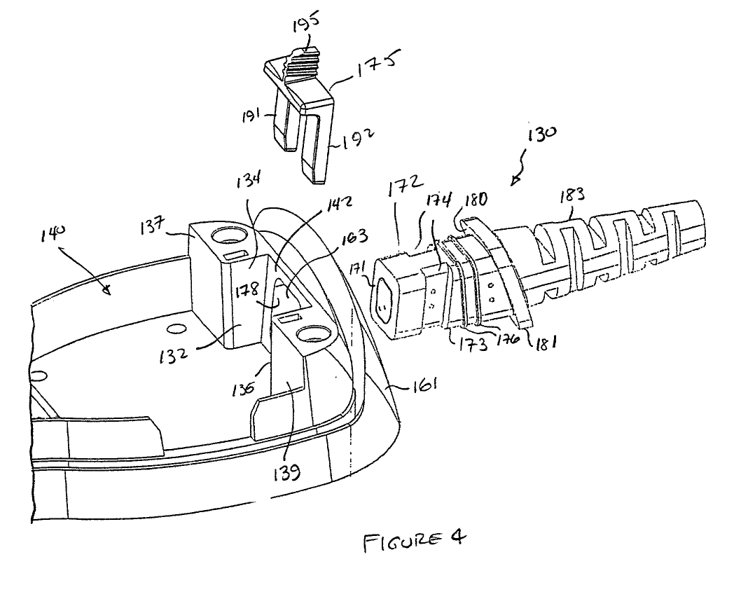

FIG. 4 diagrammatically illustrates a telephone craftsperson's test set that is configured to receive and sealingly engage the improved line cord strain relief attachment of the present invention. It should be observed that the invention is not limited to use with only a craftsperson's test set or one having the configuration shown in FIG. 4, but may be installed in other types of communication devices. Like the line cord attachment configuration of FIGS. 2 and 3, the telecommunication device (e.g., test set) includes a line cord strain relief engagement cavity 132, formed between generally flat sidewalls 134 and 136 of a pair of spaced apart mesas 137 and 139 at one end of an interior compartment 140 of the utility device (test set).

The strain relief engagement cavity 132 is terminated by a rear wall 142 that surrounds a passageway 163 extending to an exterior surface 161 of the test set body. As in the structure of FIG. 3, the line cord passageway 163 has non-round cross-section, such as the generally rectangular cross-section shown, which serves to prevent rotation of and is sized to receive a line cord strain relief element 130, the cross-sectional shape of which generally corresponds to that of passageway 163.

The line cord stain relief element 130 is preferably comprised of a suitable flexible and waterproof material, such as neoprene rubber, as a non-limiting example. A first, test set-engaging end 171 of the strain relief element 130 has a neck portion 173, having notches or grooves as shown at 174, and is sized and shaped to be inserted through the passageway 163 and into cavity 132.

As described briefly above, in accordance with the invention, the outer surface 172 of the neck portion 173 of the strain relief element is provided with one or more sealing ribs or rings 176, the functionality of which is akin to that of an O-ring as in fluid-sealing devices and applications. While the illustrated embodiment shows a pair of sealing ribs 176, it is to be understood that the invention is not limited thereto. A single sealing rib or three or more such rings or ribs may be employed, depending upon the application and the environment in which the utility device is to be employed. The sealing rib or ribs 176 may be formed as an integral part of the strain relief element, such as in the molding of the element, or they may be formed as separate elements, and thereafter placed upon and firmly (e.g., adhesively) affixed to the outer surface 172 of the neck portion 173.

The sealing ribs 176 are sized to abut against the interior wall surface 178 of the line cord-insertion passageway 163 and thereby maintain a tight moisture and foreign matter entry seal between the interior wall surface 178 of the line cord-insertion passageway 163 and the outer surface of the neck portion strain relief element 130. As noted previously, and as will be appreciated from the architecture shown in FIG. 4, this enhanced sealing functionality provided by the sealing ribs ensures that the intended tight moisture and foreign matter entry seal will be provided, even when the line cord strain relief attachment is subjected to the repeated deflections, that might otherwise disrupt a moisture barrier between the surface 180 of a flange 181 and the exterior surface 161 of the test set.

Like the structure of FIG. 3, the surface of the grooved neck portion 173 of the strain relief element 130 is non-parallel with the planar surface of the rear wall 142 of the cavity 132. As a result, the application of a plug insertion force along the grooved neck portion 173 by way of a generally inverted U-shaped, line cord retention plug 175 will cause the line cord strain relief element 130 to be drawn into the interior of the test set and retained against the surface of the rear wall 142.

The flange 181 of the line cord attachment element of the invention is configured to snugly engage the exterior surface 161 of the test set body, when the line cord strain relief element is inserted into passageway 163. Projecting from the flange 181 is a robustly flexible, protective line cord shroud 183, shown as having an undulating surface, and including a longitudinal bore therethrough that is sized to snugly receive the line cord. The distance between the flange 181 and the grooved neck portion 173 of the strain relief element 130 is such that insertion of the retention plug 175 into the test set cavity 132 will cause the line cord strain relief element 130 to be drawn or urged into the passageway 163, and thereby bring the flange 181 into snug abutment against the exterior surface 161 of the test set body.

In order to releasably secure the strain relief element 130 with the test set, the line cord retention plug 175 is configured as a generally inverted U-shaped element having a pair of leg portions 191 and 192, that are configured to fit into the grooves 174 in the neck portion 173 of the line cord strain relief element 130, and thereby enable the retention plug 175 to capture the strain relief element 130, once the retention plug 175 has been inserted into the cavity 132.

The U-shaped retention plug 175 is also provided with a nib or gripping projection 195, shown as having a ribbed ‘gripping’ surface. This nib enables the line cord retention plug to be readily manually seized, as between a user's thumb and forefinger, so as to facilitate insertion and removal of the plug with respect to the grooved neck portion of the strain relief element, without the need for a separate tool.

As will be appreciated from the foregoing description, like the line cord strain relief attachment configuration of the '590 Patent, the enhanced line cord strain relief attachment configuration of the invention not only provides robust strain relief, and a barrier against moisture and foreign matter, but facilitates replacement of the line cord. The addition of one or more sealing ribs or rings around the outer surface of the strain relief element ensures that a tight moisture and foreign matter entry seal will be maintained, even when the line cord strain relief attachment is subjected to deflection forces that might otherwise disrupt the moisture barrier intended to be provided between the strain relief element flange and the exterior surface of the test set. In addition, the gripping projection allows the plug to be readily seized between a user's thumb and forefinger, thereby allowing manual insertion and removal of the plug without the need for a special tool.

While I have shown and described an embodiment in accordance with the present invention, it is to be understood that the same is not limited thereto but is susceptible to numerous changes and modifications as are known to a person skilled in the art, and I therefore do not wish to be limited to the details shown and described herein, but intend to cover all such changes and modifications as are obvious to one of ordinary skill in the art.

What is claimed

1. A strain relief attachment for attaching an electrical line cord to a utility device, said utility device having an aperture in a body thereof, and a surface adjacent to said aperture that is configured to be engaged by a strain relief element, said electrical line cord being adapted to pass through said aperture for engagement with an electrical connector at a location within said utility device, said strain relief attachment comprising:
a line cord strain relief element, having a neck portion that is insertable through said aperture in said body of said utility device, said strain relief element including a passageway adapted to receive said line cord and a flange configured to generally conform with an external surface of said body of said utility device adjacent to said aperture;
a line cord retention plug adapted to engage said surface adjacent to said aperture in said body of said utility device, and to engage said neck portion of said line cord strain relief element, so as to draw said line cord strain relief element into said body of said utility device, and thereby urge said flange of said line cord strain relief element into sealing engagement with said external surface of said body of said utility device; and
at least one sealing rib around the outer surface of said neck portion of said strain relief element and being sized to engage an interior surface of said passageway, so as to maintain a tight moisture barrier between said interior surface of said passageway and said strain relief element.

2. The strain relief attachment according to claim 1, wherein said at least one sealing rib is integral with said neck portion of said strain relief element.

3. The strain relief attachment according to claim 1, wherein said retention plug is provided with a nib that is configured to enable said line cord retention plug to be manually seized, and thereby facilitate insertion and removal of said plug with respect to said strain relief element, without the need for a separate tool for the purpose.

4. The strain relief attachment according to claim 1, wherein said neck of said line cord strain relief element is grooved so as to receive and engage said line cord retention plug.

5. The strain relief attachment according to claim 4, wherein said line cord retention plug has a pair of leg portions that are configured to be insertable into grooves in said neck portion of said line cord strain relief element , and to also engage said strain relief element engagement surface within said utility device, so as to cause said line cord strain relief element to be drawn into said utility device, and thereby urge said flange into sealing engagement with said external surface of said body of said utility device.

6. The strain relief attachment according to claim 4, wherein said neck portion of said strain relief element is non-parallel with said strain relief element engagement surface of said body of said utility device, so that insertion of said line cord retention plug into said grooved neck portion of said line cord strain relief element causes said line cord strain relief element to be drawn into said utility device.

7. The strain relief attachment according to claim 6, wherein said line cord strain relief element further includes a shroud having a longitudinal bore sized to snugly receive said line cord, said shroud providing a weatherproof seal around the line cord as it extends through said strain relief element and into said utility device.

8. The strain relief attachment according to claim 1, wherein said utility device comprises a telephone test set.

9. A strain relief attachment for attaching a telephone communication cord to a telephone test set, said telephone test set having an aperture through which said communication cord may pass for engagement with a connector installed within said test set, and a surface adjacent to said aperture that is configured to be engaged by a strain relief element, said strain relief attachment comprising:
a communication cord strain relief element, having a grooved neck that is insertable through said aperture of said test set, said strain relief element including a bore through which said communication cord extends and a flange configured to generally conform with an external surface of said test set adjacent to said aperture;
a communication cord retention plug that is adapted to be inserted into and engage said grooved neck of said communication cord strain relief element and said strain relief element engagement surface, in such a manner as to draw said communication cord strain relief element into said test set and thereby urge said flange of said communication cord strain relief element into sealing engagement with said external surface of said test set; and
at least one sealing rib around the outer surface of said neck portion of said strain relief element and being sized to engage an interior surface of said aperture, so as to maintain a tight moisture barrier between said interior surface of said aperture and said strain relief element.

10. The strain relief attachment according to claim 9, wherein said at least one sealing rib comprises a plurality of sealing ribs integral with said neck portion of said strain relief element.

11. The strain relief attachment according to claim 9, wherein said retention plug is provided with a nib that is configured to enable said retention plug to be manually seized, and thereby facilitate insertion and removal of said plug with respect to said strain relief element, without the need for a separate tool for the purpose.

12. The strain relief attachment according to claim 9, wherein said communication cord retention plug has a pair of legs that are configured to be insertable into grooves in said neck portion of said communication cord strain relief element, and to engage said strain relief element engagement surface within said test set, so as to cause said communication cord strain relief element to be drawn into said test set and urge said flange into sealing engagement with said external surface of said test set.

13. The strain relief attachment according to claim 9, wherein said neck portion of said strain relief element is non-parallel with said a strain relief element engagement surface, so that insertion of said communication cord retention plug into said grooved neck portion of said communication cord strain relief element causes said communication strain relief element to be drawn into said test set.

14. The strain relief attachment according to claim 13, wherein said communication cord strain relief element further includes a shroud having a longitudinal bore sized to snugly receive said communication cord, so that said shroud provides weatherproof seal around said communication cord as it extends through said strain relief element and into said test set.
